(19) United States
(12) Patent Application Publication
(10) Pub. No.: US 2007/0089929 A1
(43) Pub. Date: Apr. 26, 2007

(54) PORTABLE PLATFORM, METHOD OF USING A PLATFORM, AND VEHICLES HAVING A PLATFORM

(76) Inventor: Richard A Schriewer, Montgomery, TX (US)

Correspondence Address: GILBRETH & ASSOCIATES, P.C., PO BOX 2428, BELLAIRE, TX, 77402-2428, US

(21) Appl. No.: 11/163,560

(22) Filed: Oct. 22, 2005

(51) Int. Cl. E06C 5/00

(52) U.S. Cl. 182/127

(57) ABSTRACT

A hunting stand having a support frame suitable for engagement with an all terrain vehicle, with a seat swivelably mounted to the frame, and an equipment support swivelably mounted to the frame, wherein the equipment support swivels independently of the seat.

### BACKGROUND OF THE INVENTION

1. Field of the Invention

The present invention relates to structures, to methods of using such structures, and to vehicles modified by such structures. In another aspect, the present invention relates to portable structures, to methods of using such structures, and to vehicles modified by such structures. In even another aspect, the present invention relates to portable structures for use in hunting, photography or observation, to methods of using such structures, and to vehicles modified by such structures. In even another aspect, the present invention relates to a portable hunting stand, to a method of hunting utilizing such a stand, and to all terrain vehicles having such a stand mounted thereon.

2. Description of the Related Art

Elevated stands have been in use for several years by hunters, photographers, and nature lovers as a way to observe wildlife with minimal intrusion into the environment. The prior are is replete with a number of devices or systems that enable a person to observe from a some distance above the ground. However, these and other prior art systems have significant disadvantages with regards to safety, complexity, accessibility, and adaptability.

In some situations, it is advantageous for the observer to take advantage of existing uprights, such as trees or poles, to provide support or concealment. The prior art provides a number of elevated stands designed for use with a tree, utility pole, or other upright. For example, there are stands designed to be abutted against a tree, pole or other upright, or which can be utilized to climb an upright. One limitation with such devices is the need for an upright, and not just any upright. For example, generally required is a straight, tall tree having a diameter within a specific range, and generally free of branches, as such devices usually would not work well with trees that are short, have branches low to the ground, are bent, or have a diameter that is too small or too large for the climbing stand. Another limitation is that the upright will many times create a blind spot, causing effort to look or shoot around the upright. For example, if a deer approaches the tree from behind, the hunter might not realize the deer is there, may spook the deer while moving into a better position, is forced to rotate about the torso if aiming a gun at the deer, and might not be able to shoot at the deer if the deer is approaching from an angle such that the tree interferes with the hunter's shooting position.

To eliminate reliance on an existing upright, some hunters utilize free standing elevated platforms. One group of known hunting stands provide structures that are affixed to trailers, such that they may be towed to desired hunting locations by trucks or ATVs. The stands are then elevated from their lowered positions aboard the trailers to a desired hunting height. However, these hunting stands have significant limitations that generally flow from their use of a trailer to transport and support the stand during use. First, the use of a trailer limits the mobility of the ATV and accordingly the hunter by restricting an ATV's ability to negotiate tight corners or cross streams. As a result, a hunter may be precluded from hunting in remote or desolate areas. Second, the trailer itself adds unnecessary and often prohibitive cost to the hunting stand apparatus. Finally, trailers lack the necessary stability to support hunters when hunting at significant heights. Generally, only two wheels and a few small outriggers support the hunting trailers. As a result, a single misplacement of an outrigger may result in instability of the trailer and hunting stand. When in use, such instability may result in serious injury to the hunter.

Another group of known hunting stands are attached directly to the ATV itself rather than to a distinct trailer as discussed above.

A number of patents are directed to hunting stands.

U.S. Pat. No. 4,442,919, issued Apr. 17, 1984, to Fulcher discloses a portable tower or derrick which may be easily towed to a selected location and then erected by a single operator. While in the transporting position, the lower portion of the portable tower is supported by wheel assemblies mounted on at least two of the tower support legs. A pivoting tongue assembly is affixed to the tower at one end and may be coupled to a vehicle at the other end. The tongue assembly serves to support the upper portion of the tower during horizontal transport. A winch or other mechanical means is utilized to erect the tower by controlling the pivotal motion of the tower about the end of the tongue assembly. Once erected, horizontal sections of the tongue assembly may be utilized to ascend the tower.

U.S. Pat. No. 4,614,252, issued Sep. 30, 1986, to Tarner discloses a portable observation structure removably attachable to a wheeled vehicle comprising two pairs of upright legs in a rectangular pyramidal arrangement, said legs being removably attachable to the rear portion of said vehicle, telescopically extensible legs internally slideable in the rear pair of said legs and adapted to be extended to the ground and to provide support for said structure, and a seat member attached to the upper end of said pyramidal arrangement. This structure is useful as an observation structure for a hunter, a lifeguard, or the like.

U.S. Pat. No. 4,800,986, issued Jan. 31, 1989, to Hayes discloses a collapsible tower apparatus for use on an ATV; wherein, the tower apparatus comprises a framework unit that is pivotally and reinforceable attached on one end to the front and rear racks of the ATV and wherein the other end of the framework unit is pivotally connected to a platform unit equipped with a seat unit; whereby the framework unit in conjunction with the platform unit form a protective cage for the operator of the ATV when the tower apparatus is disposed in its collapsed mode.

U.S. Pat. No. 5,295,555, issued Mar. 22, 1994, to Strange discloses a wheeled trailer chassis is provided including a flat load bed and a rear end pivotally mounted loading ramp swingable between an operative rearwardly downwardly inclined position and an upright position closing the rear of the load bed. An ATV also is provided behind which the trailer maybe trailed and the ATV is loadable over the loading ramp onto the rear portion of the load bed of the trailer. The forward portion of the trailer load bed stationarily supports a slightly rearwardly inclined upright from whose upper end the lower end of a lift boom is pivotally supported, the upper end of the lift boom having an occupant receiving receptacle pivotally supported therefrom. A parallelogram link is connected between the upright and the receptacle and hydraulic cylinders are operatively connected between the lift boom and the upright for raising and lowering the lift boom. The occupant receiving receptacle carried by the free end of the lift boom is swingable rearwardly and downwardly behind the ramp when the latter is in its upright position closing the rear of the load bed.

U.S. Pat. No. 5,297,844, issued Mar. 29, 1994, to Haustein discloses a cab and observation or hunting stand temporarily attachable to and quickly and easily removable from the front and rear racks of an ATV. The cab may be enclosed for weather protection if desired; at least one openable window and latchable door are provided. The cab may include a foldable stand on top, for use as an observation and/or hunting stand. Seating is provided in the stand, along with provision for a removable shade. Stabilization for the stand is provided by at least one stabilizer bar and an access ladder for the stand, which also serves as an additional stabilizing device. The apparatus may be camouflaged if desired, and lighting may be included within the cab for low light level operations.

U.S. Pat. No. 5,409,081, issued Apr. 25, 1995 to Reeves discloses a mobile elevated hunting apparatus from which a hunter can hunt. The apparatus includes a hunting stand having a seat for holding the hunter in a seated position, framing around the seat and one or more legs attached to the seat for elevating the seat above the ground. The apparatus further includes a motorized vehicle for supporting and transporting the hunting stand. Finally, the apparatus includes a pivot bracket connecting the hunting stand with the motorized vehicle, suitable for positioning the hunting stand in a first transporting position fully on the vehicle and for positioning the hunting stand in a second hunting position with the hunting stand legs on the ground.

U.S. Pat. No. 5,662,451, issued to Muzzi et al., Sep. 2, 1997, discloses a hoist for lifting or hanging game animals. The hoist is particularly adapted for attachment to an ATV. The hoist includes a horizontal boom attached to a vertical support shaft. The vertical support shaft is telescoping to allow the height of the boom to be varied. The hoist is attached to the ATV by a base which allows the hoist to be supported in a vertical position for lifting game, and in a horizontal position for travelling. A bracing leg is also provided to prevent the ATV from tipping when heavy weights are being lifted using the hoist.

U.S. Pat. No. 5,794,976, issued Aug. 18, 1998, to Stevicks, discloses a protective assembly for all terrain vehicles comprising a front end protector dimensioned to protect substantially all of the front end. It also comprises side rails having front and back ends which are parallel to and spaced away from the sides of the all terrain vehicle which tubular side rails are shaped to receive and have mounted thereon auxiliary front and rear fenders. There is also present a debris deflecting running board. Optional features are rear wheel mud guards and a high intensity light mounted on the steering assembly and a flood light on the rear of the vehicle.

U.S. Pat. No. 6,105,721, issued Aug. 22, 2000, to Haynes discloses an accessory for an ATV (all terrain vehicle) mounted on top of an ATV to allow the use of a stationary ATV as a hunting stand. The accessory is comprised primarily of square metallic tubular members that surround a hunter sitting on an ATV, allowing for waterproof camouflage material to be attached along the outside of the accessory to shield the ATV and user from the sight of passing game. The waterproof camouflage panels also provide a hunter with protection against the elements. The accessory allows a user to sit above the ATV on a seat located at the top of the accessory. Access to this top seat is provided by horizontal tubular members at the rear of the accessory that can be positioned for use as a ladder. The top seat allows a user to have a high vantage point for hunting. The accessory transforms an ATV into a comfortable and effective hunting stand even in an open field.

U.S. Pat. No. 6,460,907, issued Oct. 8, 2002, to Usui discloses a straddle type four-wheeled all-terrain vehicle includes: a body frame having a front end part; a front guard joined to the front end part of the body frame; and a winch unit including an electric winch and a guide roller mechanism for guiding a tow rope. The electric winch and the guide roller mechanism are arranged longitudinally from a rear toward a front in that order in a lower part of a space in the front guard.

U.S. Pat. No. 6,604,606, issued Aug. 12, 2003, to McDougal et al., discloses a portable utility stand for use by hunters, wildlife photographers, security personnel, etc., which attaches removably to a small, light weight off road vehicle (golf cart, all terrain vehicle, etc.). The stand essentially comprises a lower portion which is immovably affixed to the vehicle, and an upper portion which is pivotally attached to the upper rear of the lower portion and which folds forwardly for storage atop the lower portion of the stand on the vehicle. The upper portion of the stand includes an observation seat which is pivotally mounted to an upper platform to provide an observer with a 360 degree field of view. The seat is positioned essentially over the center of gravity of the vehicle when the stand is erected, and a pair of lateral braces is provided for additional stability and safety. A folding safety guard is also provided to surround a person seated atop the stand.

U.S. Pat. No. 6,688,429, issued Feb. 10, 2004, to McKay discloses a portable tower apparatus, convertible between a lowered transport configuration and a raised observation configuration, useful for observing wildlife and hunting, comprising an elongate main member that functions as the main structural element of a trailer assembly when the apparatus in deployed in the lowered transport configuration, and the main structural element of a freestanding tower, when the apparatus is deployed in the raised observation configuration. The apparatus is deployed in the raised tower configuration by tipping the main member up, so that the base members, attached to one end thereof, rest on the ground, attaching the platform to the other end of the main member, and attaching the brace, which is also a ladder, to the platform.

U.S. Pat. No. 6,739,428, issued May 25, 2004, to Holmes et al., discloses a portable hunting device for elevating a hunter wherein the device can be transported to and from a hunting site on a transport vehicle. When fully assembled, the hunting platform is supported by a ladder and at least two support legs. During transport the hunting platform is lowered, the ladder is folded and the support legs are removed and stored in a storage position so that the device is compact for safe transportation. Upon arrival at the desired location, the ladder is extended from a folded position to an extended position and the legs are removed from the storage position and are inserted into the leg guides where the legs are locked into position to prevent separation. A cable is connected from a hand-operated winch to the ladder so that as the winch is rotated, the ladder is rotated and the platform is raised from the transport position to the hunting position.

U.S. Pat. No. 6,948,587, issued Sep. 27, 2005, to Griffiths discloses an elevated platform configurable for use in cooperation with a tree or pole, or as a free-standing unit. A triangular assembled configuration provides maximum safety and rigidity with a minimum complexity and weight. Interchangeable components, universal connectors, and tool-free assembly result in ease and speed for assembly and disassembly. The platform is adaptable for use in any number of configurations and is transformable into a trailer for towing by a person, ATV, or vehicle. Additionally, a gun/camera rail, bow rack, weather resistant shelter, and a swivel seat provide improved comfort for extended use.

U.S. patent application Ser. No. 10/408,403, Publication Number 2004/0195042, published Oct. 7, 2004, to Smith discloses a hunting stand to be releasably attached to the rear rack area above the rear axle of a factory equipped ATV. The hunting stand or platform may be raised from its traveling position just behind the ATV operator to a desired hunting height. The stand may be raised manually by the hunter or automatically through some form of electronic or hydraulic scissor lift mechanism. Retractable outriggers extend from the base of the scissor lift mechanism to rest on the ground and provide additional stability when the stand is used on uneven terrain. Finally, the improved hunting stand includes dry boxes for ammunition storage; rifle supports for steadying a hunter's aim and a foldable or swivel seat to comfortably support the hunter during hunting activities.

U.S. patent application Ser. No. 10/760,833, Publication Number 2004/0195885, published Oct. 7, 2004, to Simpson discloses a removable seat assembly for mounting on an all-terrain vehicle, which seat assembly is characterized by a base plate frame for mounting on an ATV and receiving a fixed or rotatable pedestal or a pedestal having a rotatable pedestal flange, and a seat attached to the pedestal or the pedestal flange. The base plate frame is designed to permanently or removably weld, clamp or bolt on the utility rack of an all-terrain vehicle or mount on a seat slide, and a swivel mechanism may be interposed between the seat pedestal and the seat or between the seat pedestal and the base plate frame or seat slide to facilitate rotation of the seat with respect to the base plate frame and the all-terrain vehicle. In another embodiment a pair of support arms extend upwardly from a support arm mount secured to the rotatable seat, pedestal or pedestal flange and terminate in a top frame carrying a cover to protect and camouflage the occupant of the seat. A gun or camera rest extends from fixed attachment to the seat or to the support arms or pivotally and adjustably from a pair of brackets attached to the support arms, to facilitate resting of a shotgun, rifle or camera held by the occupant of the seat for sighting and shooting purposes. Alternatively, the support arms can be mounted directly on the base plate frame and the seat pedestal either fixed to the base plate frame or provided with a swivel to facilitate rotation of the seat with respect to the support arms and the gun rest.

In spite of the advances in the prior art, there is still a need in the art for structures, to methods of using such structures, and to vehicles modified by such structures.

There is another need in the art for portable structures, to methods of using such structures, and to vehicles modified by such structures.

There is even another need in the art for portable structures for use in hunting, photography or observation, to methods of using such structures, and to vehicles modified by such structures.

There is still another need in the art for portable hunting stands, to methods of hunting utilizing such a stand, and to all terrain vehicles having such a stand mounted thereon.

These and other needs in the art will become apparent to those of skill in the art upon review of this specification, including its drawings, claims and abstract.

### SUMMARY OF THE INVENTION

It is an object of the present invention to provide for structures, to methods of using such structures, and to vehicles modified by such structures.

It is an another object of the present invention to provide for portable structures, to methods of using such structures, and to vehicles modified by such structures.

It is even another object of the present invention to provide for portable structures for use in hunting, photography or observation, to methods of using such structures, and to vehicles modified by such structures.

It is still another object of the present invention to provide for portable hunting stands, to methods of hunting utilizing such a stand, and to all terrain vehicles having such a stand mounted thereon.

These and other needs in the art will become apparent to those of skill in the art upon review of this specification, including its drawings, claims and abstract.

According to one embodiment of the present invention, there is provided a stand comprising: a support frame suitable for engagement with a vehicle; a seat swivelably mounted to the frame; and an equipment support swivelably mounted to the frame, wherein the equipment support swivels independently of the seat.

According to another embodiment of the present invention, there is provided a mobile stand comprising: a transportation vehicle; a support frame suitable in engagement with the vehicle; a seat swivelably mounted to the frame; and an equipment support swivelably mounted to the frame, wherein the equipment support swivels independently of the seat.

These and other embodiments of the present invention will become apparent to those of skill in the art upon review of this specification, including its drawings, claims and abstract.

### BRIEF DESCRIPTION OF THE DRAWINGS

In the drawings, like reference numbers refer to like members. Similarly, between the drawings, like looking elements will have the same reference numbers, whether labeled or not.

FIG. 1 is an illustration of one non-limiting embodiment of the present invention showing a typical all terrain vehicle 10 upon which is mounted stand 100, having a seat 101, utility support 103, and an optional clear wind break 141.

FIG. 2 is an illustration of another non-limiting embodiment of the present invention showing a typical all terrain vehicle 10 upon which is mounted stand 100, having a seat 101, utility support 103, and an optional wind break 143.

FIG. 3 is an illustration of even another non-limiting embodiment of the present invention showing a typical all terrain vehicle 10 upon which is mounted stand 100, having a seat 101, utility support 103, and an optional camouflage 145.

### DETAILED DESCRIPTION OF THE INVENTION

The present invention will be described by reference to the drawings.

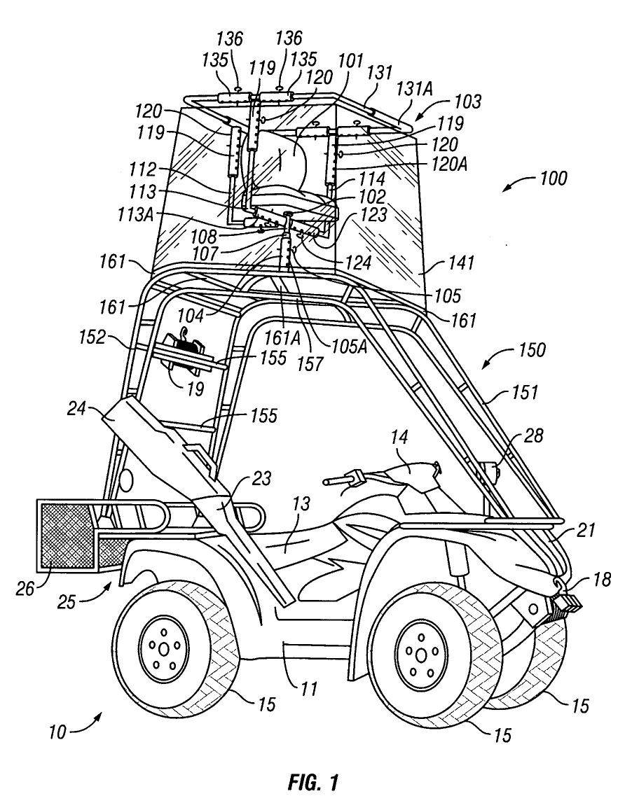

Referring now to FIG. 1, there is shown an illustration of one non-limiting embodiment of the present invention showing a typical all terrain vehicle 10 upon which is mounted stand 100, having a seat 101, utility support 103, and an optional clear wind break 141.

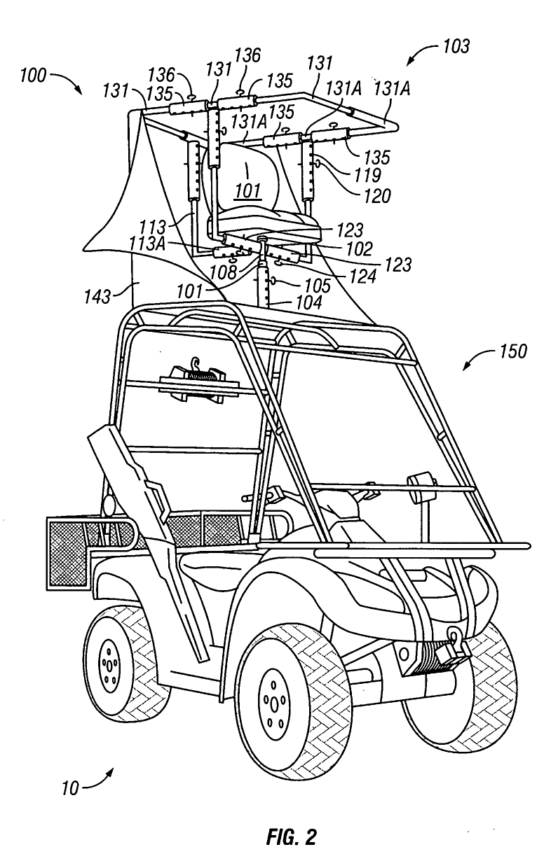

Referring additionally to FIG. 2 is shown an illustration of another non-limiting embodiment of the present invention showing a typical all terrain vehicle 10 upon which is mounted stand 100, having a seat 101, utility support 103, and an optional wind break 143.

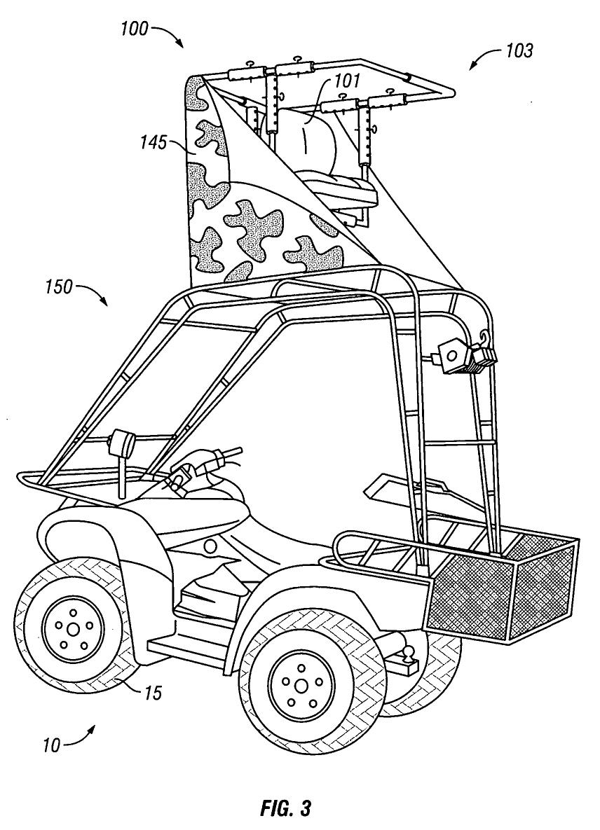

FIG. 3 is an illustration of one non-limiting embodiment of the present invention showing a typical all terrain vehicle 10 upon which is mounted stand 100, having a seat 101, utility support 103, and an optional camouflage 145.

All terrain vehicles (ATV) are well known in both the hunting and transportation the art generally having 3 or 4 wheels, and any suitable ATV, with any desired number of wheels, may be utilized as ATV 10 in the present invention.

As show in FIGS. 1-3, ATV 10 comprises a chassis 11, a plurality of wheels 15, seat 13, steering mechanism 14, a front deck portion 21, and a rear deck portion 25. Other items as shown include a gun rack 23 in which resides a gun case 24, a light 28, basket 26, a front motorized wench 18, and a rear motorized wench 19. It should be understood that any other type of accessory as desired may be incorporated into ATV 10.

While the present invention will be illustrated throughout as being utilized with an ATV, it should be understood that the present invention may be utilized with any other type of transportation vehicle as desired. Non-limiting examples of categories of such vehicles include wheeled vehicles, marine vessels, snow and ice vehicles, hauled/towed vehicles, any of which may or may not be motorized. For example, automobiles, trucks, tractor, motorcycles, recreation vehicles, tracked vehicles, train cars, trailers, boats, jet ski, air boats, snow mobiles, sleds, and skids.

Attached to ATV 10 is stand 100 having a seat 101, an equipment support 103, and support frame 150.

Support frame 150 may be made of any suitable material as required, generally metal and/or composite materials.

Support frame 150 includes front supports 151 which are anchored to ATV front deck 21. As an important feature of support frame 150, these front supports 151 are angled back to allow ease of travel through branches and brush.

Support frame 150 also includes back supports 152 which are anchored to ATV rear deck 25. Support frame 150 may also include any desired number of stabilizing supports 155 on the rear and top portions of support frame 150, and on the front angled supports 151 to the extent that such do not interfere with vision or safety. These stabilizing supports 155 may also be used to support auxiliary items, such as wench 19 as shown. Additionally, in operation, stabilizing supports function as a ladder to allow an operator to climb ATV 10 and have access to stand 100.

Support frame 150 also includes top supports 157 which form a base on which a hunter will stand/sit. Top supports 157 may also include an optional roof to cover/shield seating area 13. If this optional roof is made of rigid materials, it may also serve as flooring on which a hunter may stand/sit.

In the embodiment as shown in the drawings, vertical base support 104 extends upwardly from optional mounting base 161, with this mounting base 161 removeably affixed to frame 150. Mounting base 161 is preferably attached to frame 150 in a manner to allow for quick and easy release, in order that seat 101 and equipment support 103 may be removed from ATV 10 for use away from ATV 10. Non-limiting examples of suitable attachment devices include mechanical lock downs, snaps, wing nuts, bolts, and the like.

This mounting base 161 may be any desired shape, and may include a number of cross reinforcing members 161A as desired.

Alternately, vertical base support 104 may be attached directly frame 150 for support of seat 101 and equipment support 103.

In the embodiment as shown vertical base support 104 is a vertically extending hollow cylindrical member. Telescoped inside vertical base support 104 is height extension member 107 which, to effect a height adjustment, may be moved vertically inside vertical base support 104 and locked into place with locking pin 105 in any of a plurality of set holes 105A in support 104. As shown, height extension 107 is a vertically extending hollow cylinder member.

Axle member 108 is rotationally positioned inside height extension member 107. Rigidly affixed to axle member 108 is equipment support member 103, allowing equipment support member to swivel (rotate) relative to ATV 10.

Seat 101 is rotationally secured with seat bearing 102 in position on top of axle member 108. This arrangement allows seat 101 to swivel on top of height extension member 107 independently of rotation of member 107. As a very important feature, this arrangement allows seat 101 and equipment support 103 to swivel (rotate) independently of each other. This feature will be convenient for a circumstance where a hunter needs to rotate the equipment support 103 to re-aim a weapon, while maintaining body position in the chair (to avoid extra movement that would alert prey). While not shown, seat 101 could be affixed to another member telescoping with member 108 to allow both independent rotation and independent height adjustment.

It should be understood that seat 101 and equipment support 103 may be made independently swivelable using any suitable apparatus and methods, not just the telescoping members as shown.

An equipment rest is defined by members 131 and 131A. Although it should be understood that auxiliary items, such as pads, grids, stands, clamps, holders, and the like could be affixed to equipment support to hold equipment. For example, a molded guide conveniently designed to receive a gun barrel could be affixed to member 131 or 131A.

Equipment support 103 is adjustable both in vertical height, laterally, and longitudinally, by a number of locking pin mechanism as shown.

Vertical members 112, 113 and 114 are telescoped into height adjustment members 119 which are provided with a plurality of adjustment holes 120A for receiving locking pins 120. The top height of equipment support 103 is adjusted by removing locking pins 120, positioning the height as desired by repositioning member 119 on the vertical members 12, 113 and 114, and then inserting locking pins 120 into the suitable adjustment hole 120A.

Lateral adjustment is made similarly by use of locking pins 124 in lateral adjustment guides 123 located under seat 101, to allow telescoping movement of lateral movement adjustment members 123 and members 113. With lateral movement members 131 and 131A move in a telescoping manner.

Longitudinal adjustment is made similarly by use of locking pins 136 in longitudinal adjustment members 135, to allow telescoping movement of longitudinal adjustment members 135 and members 131. With lateral movement members 113 and 113A, located near the rear seat 101 in the figures, move in a telescoping manner.

Stand 100 may further optionally include an enclosure positioned around equipment support 103, such as a clear plastic shield 141 shown in FIG. 1, a pliable windbreak 143 shown in FIG. 2, or a camouflage cover 145 show in FIG. 3. Whether the enclosure is clear or provides a blind will depend upon the use intended. Generally, hunting will require that the enclosure provide a blind, perhaps even a camouflage blind, while normal nature observation may not require such.

It should be understood that part or all of stand 100 may be removed from ATV 10 and utilized on any other vehicle or positioned away from a vehicle, perhaps on the ground, or a tree.

It is contemplated that the entire stand 100 including seat 101, equipment support 103 and frame 150, may be removed as a unit for use elsewhere. In such an instance, frame 150 will provide some elevation.

It is also contemplated that where optional mounting base 161 is utilized, this base 161, along with seat 101 and support 103, may be removed away from frame 150. In such an instance, mounting base will provide a stable base for mounting on another vehicle or resting on the ground or in a tree.

Finally, it is contemplated that seat 101 and support 103 may be removed and utilized as a unit. Perhaps, along with axle 108 and inserted in a hollow vertical base similar to member 107.

While the present invention has been illustrated throughout as relating to hunting, it should be understood that the present invention also has utility for use in any type of activity in which observation is part of the activity, non-limiting examples of which includes nature observation, guarding,

All written materials cited herein, including patents, patent applications, articles, publications, and books, are hereby incorporated by reference for all that they disclose, suggest and teach.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which this invention pertains.

What is claimed is:

1. A stand comprising: swivel
a support frame suitable for engagement with a vehicle;
a seat swivelably mounted to the frame;
an equipment support swivelably mounted to the frame, wherein the equipment support swivels independently of the seat.

2. A mobile stand comprising:
a transportation vehicle;
a support frame suitable in engagement with the vehicle;
a seat swivelably mounted to the frame;
an equipment support swivelably mounted to the frame, wherein the equipment support swivels independently of the seat.
